(19) United States
(12) Patent Application Publication
(10) Pub. No.: US 2025/0379862 A1
(43) Pub. Date: Dec. 11, 2025

(54) SECURE AUTHENTICATION OF DIGITAL HUMANS

(71) Applicant: Charter Communications Operating, LLC, St. Louis, MO (US)

(72) Inventors: Gary Steven Koerper, Castle Pines, CO (US); Dell Lawrence Wolfensparger, Littleton, CO (US)

(21) Appl. No.: 18/738,765

(22) Filed: Jun. 10, 2024

(51) Int. Cl. H04L 9/40; G06V 40/16; G10L 17/00; H04N 7/14

(52) U.S. Cl. CPC H04L 63/0861; G06V 40/172; G06V 40/176; G10L 17/00; H04N 7/14

(57) ABSTRACT

A video stream that depicts at least the face of an individual, and information identifying a known individual is received. Predetermined validation data derived from the known individual is accessed. An analysis of a segment of the video stream based on the predetermined validation data is performed. Based on the analysis, an output signal indicative of a confidence level that the video stream is a video stream generated by the known individual is provided.

### BACKGROUND

Technologies related to image generation and image animation make it increasingly easy for one individual to generate animated imagery of a second individual that is sufficiently realistic to fool viewers of the animated imagery into thinking that the second individual actually generated the animated imagery. Such technologies can be used for beneficial purposes or for nefarious purposes.

### SUMMARY

The implementations described herein can eliminate or render extremely unlikely the possibility that a nefarious individual can successfully pass off imagery, such as a deep fake video or a digitized avatar, that purportedly depicts another individual for which predetermined validation data exists.

In one implementation a method is provided. The method includes receiving, by a computing device, a video stream that depicts at least a face of an individual, and information identifying a known individual. The method further includes accessing, by the computing device, predetermined validation data derived from the known individual. The method further includes performing an analysis, by the computing device, of a segment of the video stream based on the predetermined validation data The method further includes providing, by the computing device based on the analysis, an output signal indicative of a confidence level that the video stream is a video stream generated by the known individual.

In another implementation a computing device is provided. The computing device includes a memory, and a processor device coupled to the memory operable to receive a video stream that depicts at least a face of an individual, and information identifying a known individual. The processor device is further operable to access predetermined validation data derived from the known individual. The processor device is further operable to perform an analysis of a segment of the video stream based on the predetermined validation data. The processor device is further operable to provide, based on the analysis, an output signal indicative of a confidence level that the video stream is a video stream generated by the known individual.

In another implementation a non-transitory computer-readable storage medium is provided. The non-transitory computer-readable storage medium includes executable instructions operable to cause one or more processor devices to receive a video stream that depicts at least a face of an individual, and information identifying a known individual. The instructions are further operable to cause the one or more processor devices to access predetermined validation data derived from the known individual. The instructions are further operable to cause the one or more processor devices to perform an analysis of a segment of the video stream based on the predetermined validation data. The instructions are further operable to cause the one or more processor devices to provide, based on the analysis, an output signal indicative of a confidence level that the video stream is a video stream generated by the known individual.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which secure authentication of digital humans can be practiced according to some implementations;

FIG. 2 is a block diagram of an environment in which secure authentication of digital humans can be practiced according to other implementations;

FIG. 3 is a flowchart of a method for secure authentication of digital humans according to some implementations;

FIG. 4 is a block diagram of an environment suitable for generating data used to derive predetermined validation data of a known individual according to some implementations;

FIG. 5 is a block diagram of an environment suitable for generating predetermined validation data of a known individual from high-resolution images and/or audio data generated in the environment discussed above with regard to FIG. 4;

FIG. 6 is a block diagram of an environment in which secure authentication of digital humans can be practiced according to other implementations; and

FIG. 7 is a block diagram of the computing device 14 suitable for implementing examples disclosed herein according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Technologies related to image generation and image animation make it increasingly easy for one individual to generate animated imagery of a second individual that is sufficiently realistic to fool viewers of the animated imagery into thinking that the second individual actually generated the animated imagery. Such technologies can be used for beneficial purposes or for nefarious purposes.

Nefarious purposes can include convincing entities, such as individuals or businesses, to perform certain acts, such as transferring money or other items of value. For example, a nefarious first individual can generate a photorealistic avatar that depicts a second individual. The first individual can initiate a video call, such as a Zoom® video call, with a third individual. The first individual utilizes software that animates the avatar in realtime in a manner that mimics the first individual's movements, such as the movement of first individual's lips, eyes, and head while speaking. The third individual sees what appears to be real video of the second individual and believes that they are conversing with the second individual, and may be requested by the first individual, via the avatar, to perform some act, such as provide money, that the third individual would not do if someone other than the second individual requested the act. Other nefarious purposes include the generation of video imagery that seemingly depicts a particular individual engaging in some activity that in fact the particular individual has never engaged in.

The examples disclosed herein implement secure authentication of digital humans. The examples generate predetermined validation data derived from the known individual. Subsequently a video stream purporting to depict the known individual is received. A segment of the video stream is analyzed based on the predetermined validation data. Based on the analysis an output signal indicative of whether the video stream is a video stream generated by the known individual is provided. By way of non-limiting example, the output signal may quantify a confidence level, such as 75%, 95% or 100% that the video stream is a video stream generated by the known individual. The output signal may, in other implementations be represented by a single value, such as Yes or No.

The predetermined validation data may comprise, for example, high-resolution imagery of the known individual. The predetermined validation data may comprise, for example, digital audio data generated from voice signals of the known individual. The predetermined validation data may comprise, for example, motion capture (mocap) data that quantifies real-time movements of the known individual. Such movements can include, by way of non-limiting example, macro and micro facial expressions, head movements, body movements, hand movements, and the like.

The analysis can include generating mocap data, based on the video, that quantities real-time movements of the individual depicted in the video and comparing the mocap data to the predetermined mocap data of the known individual. The analysis can include inputting one or more images from of the video stream into a machine learned model (MLM) that has been trained with, for example, imagery depicting facial muscles and/or facial wrinkles of the known individual, and receiving an output quantifying a confidence that the facial muscles and/or facial wrinkles depicted in the segment of the video stream are the facial muscles and/or facial wrinkles of the known individual.

The analysis can include inputting one or more images from the video stream into a MLM that has been trained with, for example, imagery depicting hair of the known individual, and receiving an output quantifying a confidence that the hair depicted in the segment of the video stream is the hair of the known individual. The analysis can include inputting one or more images from the video stream into a MLM that has been trained with, for example, imagery depicting skin of the known individual, and receiving an output quantifying a confidence that the skin depicted in the segment of the video stream is the skin of the known individual. The analysis can include comparing, by the computing device, audio data contained in the segment of the video stream to audio data generated from voice signals of the known individual. Based on one or more of the analyses described above, a score or other metric can be generated that is indicative of whether the video stream is a video stream generated by the known individual.

The implementations described herein can eliminate or render extremely unlikely the possibility that a nefarious individual can successfully pass off imagery, such as a deep fake video or a digital avatar, that purportedly depicts another individual for which predetermined validation data exists.

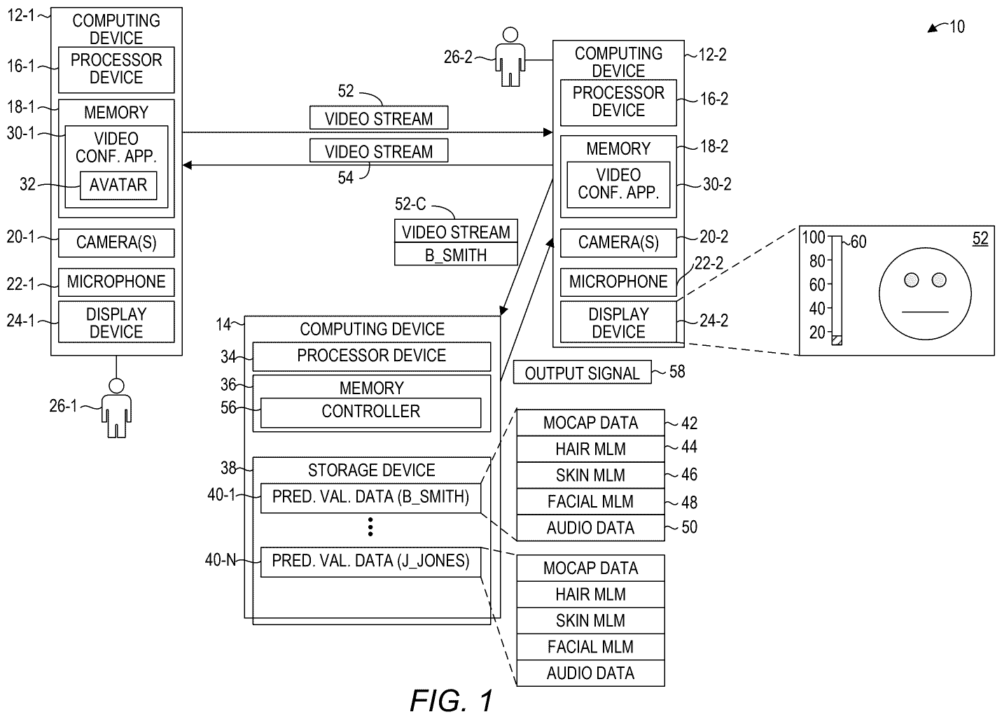

FIG. 1 is a block diagram of an environment 10 in which secure authentication of digital humans can be practiced according to some implementations. The environment 10 includes two computing devices 12-1 and 12-2 (generally, computing devices 12) that are engaging in a video call. The computing devices 12-1, 12-2 include processor devices 16-1, 16-2 and memories 18-1, 18-2 respectively. The computing devices 12-1, 12-2 include, or are communicatively coupled to, cameras 20-1, 20-2, microphones 22-1, 22-2, and display devices 24-1, 24-2, respectively. The computing devices 12 may comprise, by way of non-limiting example, smartphones, computing tablets, laptop computing devices, desktop computing devices, audio/video conferencing devices, or the like.

The computing device 12-1 includes a video conferencing application 28-1 that facilitates video calls between individuals. The term “video call” as used herein refers to a communication session wherein each participant in the call can stream, in real-time, a video stream comprising imagery to the other parties participating in the call. The video stream typically includes, or accompanies, a real-time audio stream of the voice of the participant, or participants, who are currently speaking.

The video conferencing application 28-1 is an application that allows the user 26-1 to utilize the camera 20-1 to live stream imagery of the user 26-1 to the user 26-2 during a video call. Alternatively, the video conferencing application 28-1 allows the user 26-1 to generate, prior to the call, an avatar that will be live streamed to the user 26-2 in lieu of actual real-time imagery of the user 26-1. The video conferencing application 28-1 allows the user 26-1 to generate the avatar from images of the user 26-1 so that the avatar appears, to the user 26-2, to be real-time imagery of the user 26-1. The video conferencing application 28-1 may animate the avatar, such as the avatar's head and lips, in real-time during the video call based on imagery captured by the camera 20-1 of the user 26-1. In particular, the video conferencing application 28-1 may include technology that can, in real-time, detect movements of the user 26-1 in the imagery captured by the camera 20-1, such as head, eye and lip movements, and replicate the movements in the avatar. Alternatively the video conferencing application 28-1 may animate only the lips of the avatar in real-time based on the words captured by the microphone 22-1. In particular, the video conferencing application 28-1 may include technology that can, in real-time, convert the speech signals of the user 26-1 to words, and, based on the words, apply lip animations to the avatar. The phrase “in real-time” as used herein refers to two things occurring essentially at the same time, other than a miniscule delay, such as in microseconds or milliseconds, necessary for computer processing to occur.

In this example, the user 26-1 is a nefarious individual who has used imagery of another individual, referred to herein as B_SMITH, who is known to and trusted by the user 26-2 to generate an avatar 32, and configured the video conferencing application 30-1 to stream the avatar 32. Thus, the avatar 32 comprises realistic imagery of B_SMITH and not of the user 26-1. The user 26-1 obtained the imagery of B_SMITH from images posted to various social websites by B_SMITH, or from other means.

A computing device 14 includes a processor device 34 and a memory 36. The computing device 14 includes, or is communicatively coupled to a storage device 38. The storage device 38 includes predetermined validation data 40-1-40-N (generally, predetermined validation data 40) for a plurality of different individuals.

The predetermined validation data 40-1 was derived from B_SMITH, and may include, by way of non-limiting example, mocap data 42 that quantifies real-time movements of B_SMITH. Such movements can include, by way of non-limiting example, macro and micro facial expressions, head movements, body movements, hand movements, and the like. The predetermined validation data 40-1 may include a hair MLM 44 that has been trained with high-resolution imagery depicting hair of B_SMITH. The hair MLM 44 is trained to receive imagery of hair and generate an output quantifying a confidence (e.g., a probability) that the hair depicted in the imagery is the hair of B_SMITH. The predetermined validation data 40-1 may include a skin MLM 46 that has been trained with high-resolution imagery depicting skin of B_SMITH. The skin MLM 46 trained to receive imagery of skin generate an output quantifying a confidence (e.g., a probability) that the skin depicted in the imagery is the skin of B_SMITH.

The predetermined validation data 40-1 may include a facial MLM 48 that has been trained with high-resolution imagery depicting facial muscles and/or facial wrinkles of B_SMITH. The facial MLM 48 is trained to receive imagery depicting facial muscles and/or facial wrinkles and generate an output quantifying a confidence (e.g., a probability) that the facial muscles and/or facial wrinkles depicted in the imagery are the facial muscles and/or facial wrinkles of B_SMITH. The predetermined validation data 40-1 may include audio data 50 generated from voice signals of B_SMITH. The predetermined validation data 40-N may comprise similar data as described above for the predetermined validation data 40-1, but will be based on a different individual, in this example, J_JONES. Mechanisms for generating the predetermined validation data 40 will be described in greater detail below.

The user 26-1 interacts with the video conferencing application 30-1 to send an invite to the computing device 12-2 to initiate a video call with a user 26-2 associated with the computing device 12-2. A video conferencing application 30-2, which may be a copy of the video conferencing application 30-1, receives the invite and notifies the user 26-2. The user 26-2 interacts with the video conferencing application 30-2 to indicate a desire to accept the call. The video conferencing application 30-2 sends a communication to the video conferencing application 30-1 indicating that the invitation has been accepted.

The video conferencing application 30-1 generates and sends a continuous video stream 52 to the video conferencing application 30-2. The video stream 52 depicts the avatar 32, which includes imagery of the face of B_SMITH. The video stream 52 may include an audio stream that includes speech signals of the user 26-1. Substantially concurrently, the video conferencing application 30-2 may generate and send a continuous video stream 54 to the video conferencing application 30-1. The video stream 54 is generated based on imagery captured by the camera 20-2 and depicts the user 26-2.

The video conferencing application 30-2 sends a video stream 52-C comprising a plurality of images at a particular framerate, such as 30 frames per second (fps) or 60 fps, to a controller 56 that executes in the memory 36 of the computing device 14, and an identifier identifying B_SMITH, because the video stream 52 purportedly depicts B_SMITH and not the user 26-1. The video stream 52-C contains all or some of the images from the video stream 52. In some implementations, the video stream 52-C may include, for example, every third or every fourth image from the video stream 52. The identifier identifying B_SMITH may be generated automatically by the video conferencing application 30-2 based on information associated with the video stream 52, such as an address of the computing device 12-1, or identifier information that purportedly identifies B_SMITH as the originator of the video call. Alternatively, the user 26-2 may interact with the video conferencing application 30-2 and instruct the video conferencing application 30-2 to use identifier information that identifies B_SMITH.

The controller 56 receives the video stream 52-C and processes at least a segment of the video stream 52-C based on the predetermined validation data 40-1, based on the identifier information that identifies B_SMITH. Based on the analysis, the controller 56 provides an output signal 58 indicative of a confidence level that the video stream 52 is a video stream generated by B_SMITH. The term “generated by” in this context means that the video stream comprises actual imagery of B_SMITH and was not, for example, generated via artificial intelligence or some other means, and the words spoken in the video stream are being spoken by B_SMITH and not some other individual and were not generated via artificial intelligence or some other means.

The video conference application 30-2 receives the output signal 58 and may present on the display device 24-2 information that quantifies the output signal 58 for the user 26-2. In this example, the video conference application 30-2 generates a vertical bar chart 60 that quantifies the output signal 58. The video conference application 30-2 may present the vertical bar chart 60 concurrently with the video stream 52 on the display device 24-2. In this example, the video conference application 30-2 overlays the vertical bar chart 60 on top of a portion of the video stream 52.

As will be described in greater detail below, the controller 56 may analyze the video stream 52-C using each of the mocap data 42, the hair MLM 44, the skin MLM 46, the facial MLM 48 and the audio data 50. The controller 56 may wait to generate the output signal 58 until each of the analyses have been completed. The controller 56 may generate a score based on each individual analysis and then generate an aggregate score reflected in the output signal 58. Alternatively the controller 56 may immediately send the output signal 58 based on an initial analysis, such as an analysis based on the mocap data 42, and then update the output signal 58 based on each additional analysis. In such implementations, the vertical bar chart 60 may change over time, such as over the course of several seconds, as the confidence level that the video stream 52 is a video stream generated by B_SMITH may change as each analysis is completed.

The user 26-2 may participate in the voice call with the user 26-1 (who is purporting to be B_SMITH) while concurrently viewing the vertical bar chart 60. Within seconds of the initiation of the voice call, the user 26-2 may conclude, based on the vertical bar chart 60, that the video stream was not generated by B_SMITH, and may terminate the voice call prior to providing any relevant information to the user 26-1.

It is understood that the vertical bar chart 60 is but one way to visually quantify the output signal 58, and that any suitable mechanism may be used. For example, the video conference application 30-2 may generate a textual description that quantifies the output signal 58, such as words “Yes” or “No”, or “Valid” or “Invalid”, or any other suitable description operable to quantify the output signal 58 to the user 26-2.

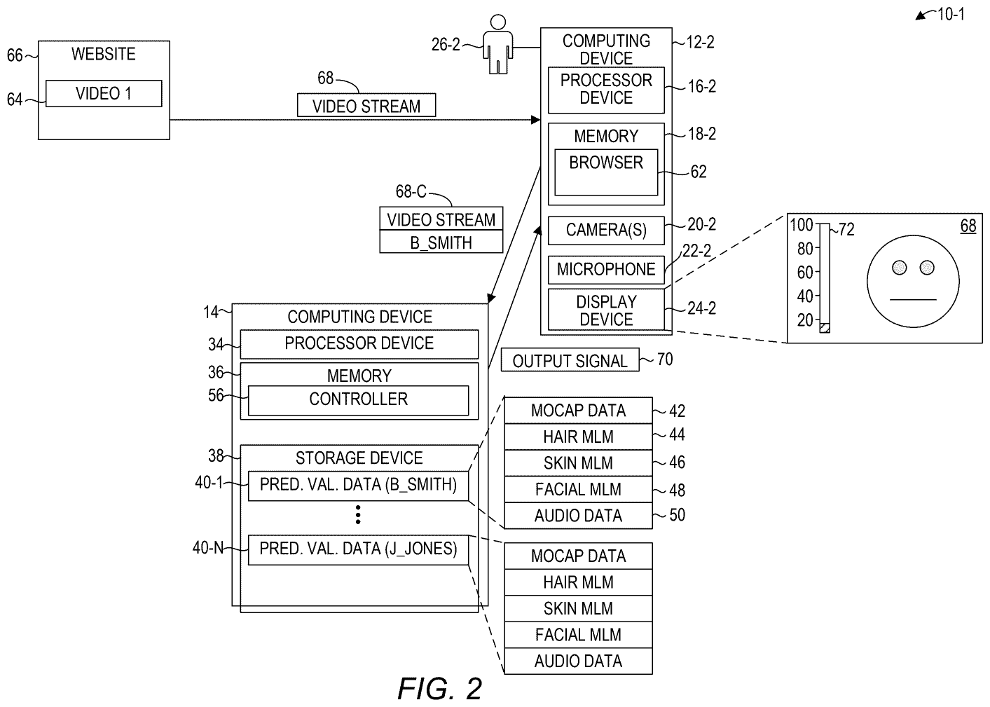

FIG. 2 is a block diagram of an environment 10-1 in which secure authentication of digital humans can be practiced according to other implementations. The environment 10-1 is substantially similar to the environment 10 except as otherwise described herein. In this implementation the user 26-2 interacts with an application, such as a web browser 62, to view a video 64 located on an Internet website 66. The video 64 was generated by the nefarious user 64-1 and purports to depict B_SMITH. In this example, the user 64-1 used an AI engine and imagery of B_SMITH to generate animated imagery of B_SMITH stating various things that B_SMITH has in fact never stated. The video 64 may comprise, for example, a deep fake video.

The browser 62 interacts with the web site 66 to initiate a video stream 68 of the video 64. The browser 62 sends a video stream 68-C comprising a plurality of images at a particular framerate to the controller 56, and an identifier identifying B_SMITH, because the video stream 68 purportedly depicts B_SMITH. The video stream 68-C contains all or some of the images from the video stream 68. The identifier identifying B_SMITH may be generated automatically by the browser 62 based on information associated with the video stream 68, such metadata that accompanies the video stream 68. Alternatively, the user 26-2 may interact with the browser 62 and instruct the browser 62 to use identifier information that identifies B_SMITH.

The controller 56 receives the video stream 68-C and processes at least a segment of the video stream 68-C based on the predetermined validation data 40-1, based on the identifier information that identifies B_SMITH. Based on the analysis, the controller 56 provides an output signal 70 indicative of a confidence level that the video stream 68 is a video stream generated by B_SMITH. Again, the term “generated by” in this context means that the video stream comprises actual imagery of B_SMITH and was not, for example, generated via artificial intelligence or some other means, and the words spoken in the video stream are being spoken by B_SMITH and not some other individual and were not generated via artificial intelligence or some other means.

The browser 62 receives the output signal 70 and may present on the display device 24-2 information that quantifies the output signal 70 for the user 26-2. Again, in this example, the video conference application 30-2 generates a vertical bar chart 72 that quantifies the output signal 70. The browser 62 may present the vertical bar chart 72 concurrently with the video stream 68 on the display device 24-2. In this example, the browser 62 overlays the vertical bar chart 72 on top of a portion of the video stream 68.

As described above with regard to FIG. 1, the controller 56 may analyze the video stream 52-C using each of the mocap data 42, the hair MLM 44, the skin MLM 46, the facial MLM 48 and the audio data 50. The controller 56 may wait to generate the output signal 70 until each of the analyses have been completed. The controller 56 may generate a score based on each individual analysis to generate an aggregate score reflected in the output signal 70. Alternatively the controller 56 may immediately send the output signal 70 based on an initial analysis, such as an analysis based on the mocap data 42, and then update the output signal 70 based on each additional analysis. In such implementations, the vertical bar chart 72 may change over time, such as over the course of several seconds, as the confidence level that the video stream 68 is a video stream generated by B_SMITH may change as each analysis is completed.

The user 26-2 may view the video stream 68 and while concurrently viewing the vertical bar chart 72. Within seconds of viewing the video stream 68, the user 26-2 may conclude, based on the vertical bar chart 72, that the video stream 68 was not generated by B_SMITH.

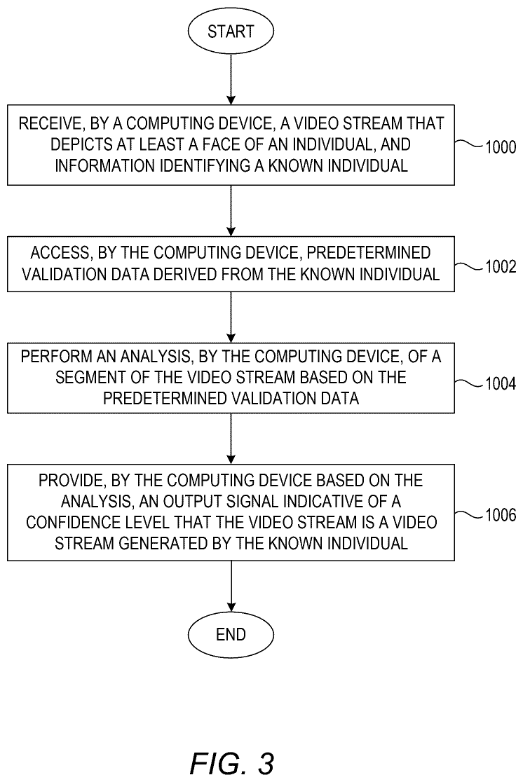

FIG. 3 is a flowchart of a method for secure authentication of digital humans according to some implementations. FIG. 3 will be discussed in conjunction with FIG. 2. The computing device 14 receives the video stream 68-C that depicts at least the face of an individual, and information identifying a known individual, in this example, B_SMITH (FIG. 2, block 1000). The computing device 14 accesses the predetermined validation data 40-1 derived from the known individual in this example, B_SMITH (FIG. 2, block 1002). The computing device 14 performs an analysis of a segment of the video stream 68-C based on the predetermined validation data 40-1 (FIG. 2, block 1004). The computing device 14 provides, based on the analysis, the output signal 58 indicative of a confidence level that the video stream 52-C is a video stream generated by the known individual (FIG. 2, block 1006).

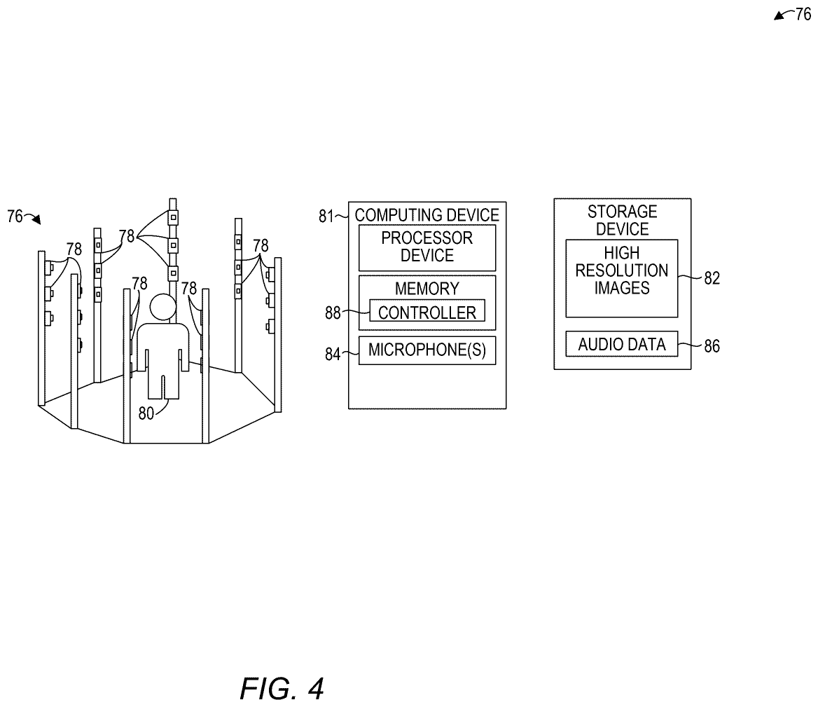

FIG. 4 is a block diagram of an environment 74 suitable for generating data used to derive the predetermined validation data according to some implementations. The environment 74 includes a photogrammetry rig 76 that includes a plurality of cameras 78 that surround an individual 80 that is positioned, either standing or sitting, in the center of the photogrammetry rig 76. For purposes of illustration it will be assumed that the individual 80 is B_SMITH. The cameras 78 may include video cameras and static image cameras. The cameras 78 may be very high resolution cameras capable of generating 4K or higher resolution imagery. A controller 88 executing on a computing device 81 controls the cameras 78 to generate a plurality of high resolution images 82, some of which are in the form of videos and some in the form of static images.

The environment 74 also includes one or more microphones 84. The controller 88 may prompt the individual 80 to say certain words and or sentences, or, the individual 80 may read words from a teleprompter (not illustrated). The words spoken by the individual 80 are captured by the microphones 84 and stored as digitized audio data 86. The facial expressions made by the individual 80 while speaking the words are captured in the high resolution images 82.

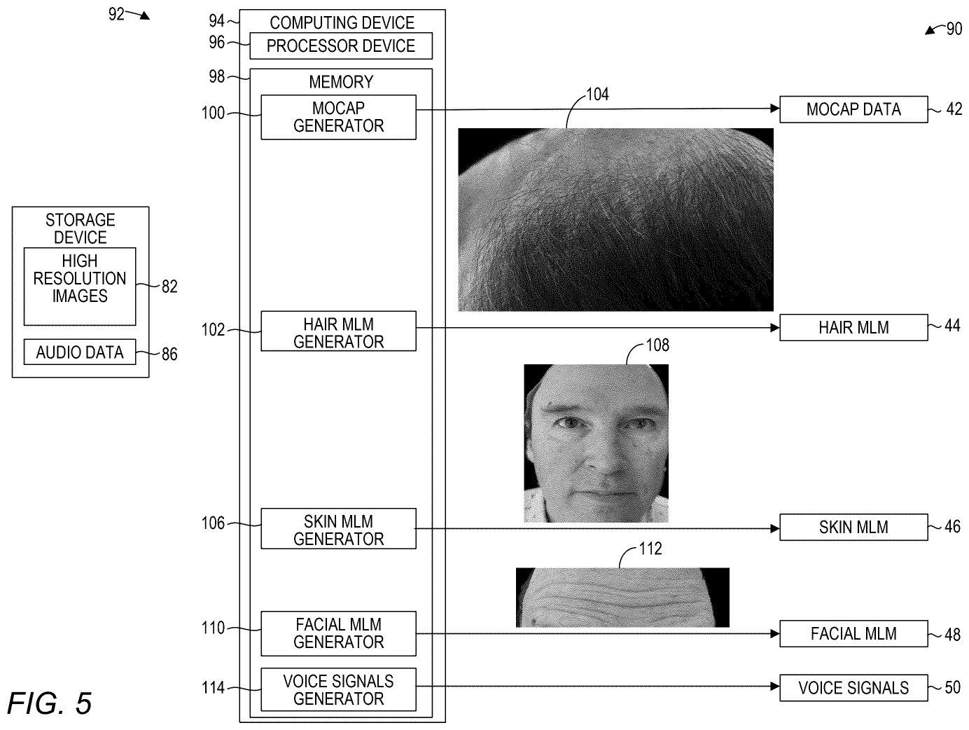

FIG. 5 is a block diagram of an environment 90 suitable for generating predetermined validation data from the high-resolution images 82 and/or the audio data 86 generated in the environment 74 discussed above with regard to FIG. 4. The environment 90 includes a computing system 92 that includes one or more computing devices 94. While for the purposes illustration only one computing device 94 is illustrated, in practice, the generation of the predetermined validation data 40 may occur on any number of computing devices 94.

The computing device 94 includes a processor device 96 and a memory 98. The computing device 94 includes, or has access to, the high-resolution images 82 and/or the audio data 86 generated in the environment 74 discussed above with regard to FIG. 4.

The computing device 94 includes a mocap generator 100 that is operable to analyze the high-resolution images 82 and generate the mocap data 42 that quantifies real-time movements of the individual 80. Such movements can include, by way of non-limiting example, macro and micro facial expressions, lip movements, head movements, and the like. The mocap data 42 may quantify certain movements of the individual 80, as illustrated in Table 1, below. The mocap generator 100 may comprise any suitable mocap generation technology, such as, by way of non-limiting example, Apple's® TrueDepth Camera.

TABLE 1

| | MoCap Range | MoCap Range |
|---|---|---|
| Blendshape | Begin | End |
| EyeLookUpLeft | 0.748229384 | 0.416793148 |
| EyeLookUpRight | 0.577407673 | 0.137834605 |
| EyeLookDownLeft | 0.388595328 | 0.243153465 |
| EyeLookDownRight | 0.511207797 | 0.014702605 |
| EyeLookInLeft | 0.48526421 | 0.97163135 |
| EyeLookInRight | 0.180234373 | 0.242525112 |
| EyeLookOutLeft | 0.2353417 | 0.996407834 |
| EyeLookOutRight | 0.704914261 | 0.055434716 |
| EyeBlinkLeft | 0.026831323 | 0.123001465 |
| EyeBlinkRight | 0.356305745 | 0.184233574 |
| EyeSquintLeft | 0.790090934 | 0.18374906 |
| EyeSquintRight | 0.563427469 | 0.884128955 |
| EyeWideLeft | 0.880924487 | 0.384080551 |
| EyeWideRight | 0.183262585 | 0.576768222 |
| JawOpen | 0.352857882 | 0.586214502 |
| JawForward | 0.642686268 | 0.713439553 |
| JawLeft | 0.646397474 | 0.011490144 |
| JawRight | 0.953228189 | 0.990097159 |
| MouthFunnel | 0.299019423 | 0.144655709 |
| MouthPucker | 0.507632199 | 0.860080589 |
| MouthLeft | 0.212502054 | 0.061630114 |
| MouthRight | 0.21756953 | 0.323858966 |
| MouthRollUpper | 0.649235503 | 0.437534118 |
| MouthRollLower | 0.676769373 | 0.230479282 |
| MouthShrugUpper | 0.543105482 | 0.672148563 |
| MouthShrugLower | 0.747187618 | 0.384631299 |
| MouthClose | 0.585709735 | 0.779242601 |
| MouthSmileLeft | 0.175789201 | 0.826538182 |
| MouthSmileRight | 0.034963707 | 0.426142472 |
| MouthFrownLeft | 0.650392605 | 0.945760812 |
| MouthFrownRight | 0.40260237 | 0.248155989 |
| MouthStretchLeft | 0.959664771 | 0.639858979 |
| MouthStretchRight | 0.283310669 | 0.693313691 |
| MouthDimpleLeft | 0.298717069 | 0.076037976 |
| MouthDimpleRight | 0.442626526 | 0.253306084 |
| MouthUpperUpLeft | 0.135399857 | 0.350690842 |
| MouthUpperUpRight | 0.648889301 | 0.828160719 |
| MouthLowerDownLeft | 0.249269116 | 0.367687526 |
| MouthLowerDownRight | 0.693050214 | 0.742570547 |
| MouthPressLeft | 0.445265975 | 0.684601288 |
| MouthPressRight | 0.79191101 | 0.159334057 |
| TongueOut | 0.261378695 | 0.59396229 |
| BrowInnerUp | 0.524022334 | 0.841796003 |
| BrowDownLeft | 0.773315887 | 0.646271063 |
| BrowDownRight | 0.796219074 | 0.196497721 |
| BrowOuterUpLeft | 0.325155712 | 0.283942931 |
| BrowOuterUpRight | 0.2038348 | 0.76242903 |
| CheekPuff | 0.350552865 | 0.002309393 |
| CheekSquintLeft | 0.907582644 | 0.966608396 |
| CheekSquintRight | 0.485463344 | 0.942480996 |
| NoseSneerLeft | 0.354434452 | 0.75905216 |

### Example of Mocap Data

The computing device 94 includes a hair MLM generator 102 that is operable to train the hair MLM 44 based on hair of the individual 80 depicted in the high-resolution images 82, such as an image 104 illustrating a hairline of the individual 80. The hair images may include, for example, hair on the head of the individual 80, eyebrow hair, hair layout, and the like. The hair MLM generator 102 may utilize hundreds or thousands of images that depict various aspects of the hair of the individual 80 until the hair MLM 44 has a prediction accuracy above a certain threshold. The hair MLM 44 is trained to receive imagery of hair and generate an output quantifying a confidence (e.g., a probability) that the hair depicted in the imagery is the hair of B_SMITH. In this manner, the hair MLM 44 is able to distinguish actual imagery of B_SMITH from imagery that is not of B_SMITH, or imagery of B_SMITH that has been generated using artificial intelligence, due to the artifacts introduced by AI, or the inability of AI to perfectly match actual imagery.

The computing device 94 includes a skin MLM generator 106 that is operable to train the skin MLM 46 based on images of the skin of the individual 80 depicted in the high-resolution images 82, such as an image 108 illustrating a face of the individual 80. Such images may depict moles, pores, skin blemishes, eye color, eye shape, nose shape, and other aspects of the individual 80. The skin MLM generator 106 may utilize hundreds or thousands of images that depict various aspects of the skin of the individual 80 until the skin MLM generator 106 has a prediction accuracy above a certain threshold. The skin MLM 46 trained to receive imagery of skin generate an output quantifying a confidence (e.g., a probability) that the skin depicted in the imagery is the skin of B_SMITH. In this manner, the skin MLM 46 is able to distinguish actual imagery of B_SMITH from imagery that is not of B_SMITH, or imagery of B_SMITH that has been generated using artificial intelligence, due to the artifacts introduced by AI, or the inability of AI to perfectly match actual imagery.

The computing device 94 includes a facial MLM generator 110 that is operable to train the facial MLM 48 based on images of muscles and wrinkles of the individual 80 depicted in the high-resolution images 82, such as a high-resolution image 112 illustrating muscles and wrinkles on a forehead of the individual 80. The facial MLM generator 110 may utilize hundreds or thousands of images that depict various aspects of the facial muscles and/or wrinkles of the individual 80 until the facial MLM generator 110 has a prediction accuracy above a certain threshold. The facial MLM 48 is trained to receive imagery depicting facial muscles and/or facial wrinkles and generate an output quantifying a confidence (e.g., a probability) that the facial muscles and/or facial wrinkles depicted in the imagery are the facial muscles and/or facial wrinkles of B_SMITH. In this manner, the facial MLM 48 is able to distinguish actual imagery of B_SMITH from imagery that is not of B_SMITH, or imagery of B_SMITH that has been generated using artificial intelligence, due to the artifacts introduced by AI, or the inability of AI to perfectly match actual imagery.

The computing device 94 includes a voice signal formatter 114 that is operable to format the audio data 86 into the audio data 50 for subsequent comparison to voice signals of a digital human.

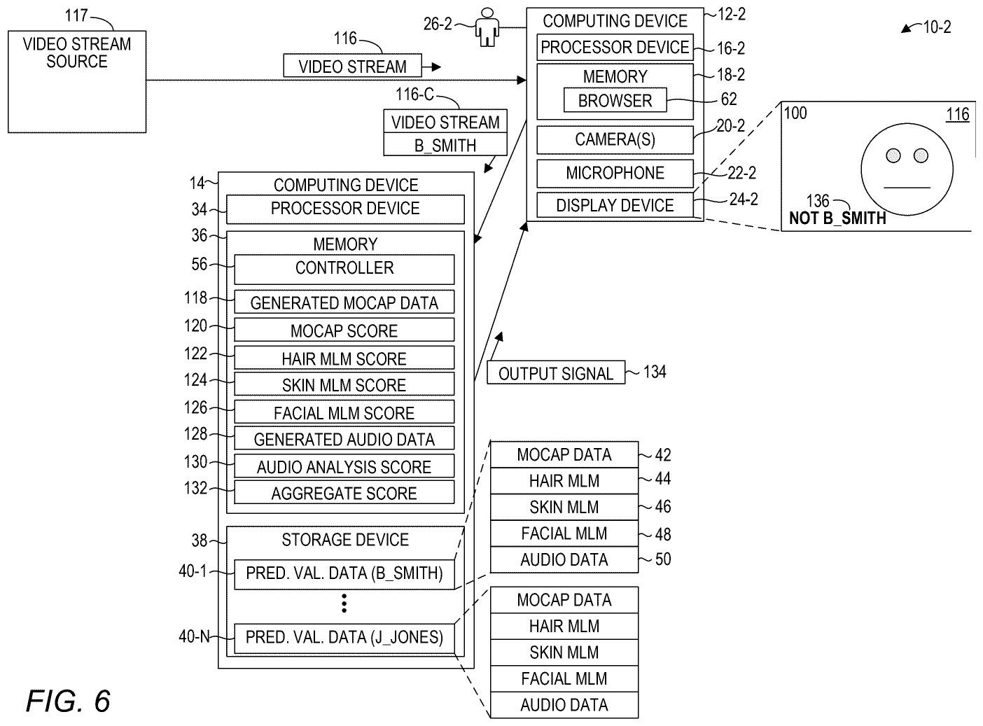

FIG. 6 is a block diagram of an environment 10-2 according to one implementation. The environment 10-2 is substantially similar to the environments 10 and 10-1 except as otherwise described herein. A more detailed explanation of the analysis of a segment of a video stream, as discussed above with regard to FIGS. 1 and 2, will be presented. The computing device 12-2 receives a video stream 116 that purports to depict an individual known and/or trusted by the user 26-2 from a video stream source 117. The video stream 116 may be generated in real-time by another computing device, as illustrated in FIG. 1, or may be pre-recorded, as illustrated in FIG. 2. The browser 62 begins to receive the video stream 116. The browser 62 generates information identifying a known individual that is purported to be depicted in the video stream 116. The information may comprise, for example, a name of the known individual, a unique identifier associated with the known individual, or any other information suitable for identifying the known individual. The information may be generated based on an initial analysis of the video stream 116, or on metadata that accompanied the video stream 116, such as a source address associated with the video stream 116, a URL associated with the video stream 116, or may be based on external information, such as information contained in a calendar invitation of the user 26-2, or input from the user 26-2.

In this example, again, it will be assumed that the known individual is B_SMITH. The browser 62 generates a copy of the video stream 116, illustrated as video stream 116-C. The copy may be an exact duplicate, or audio data a video stream that has a reduced framerate from the video stream 116. For example, the video stream 116 may have a 60 frames per second (FPS) framerate and the browser 62 may generate the video stream 116-C to have a 15 FPS framerate, by including every fourth image from the video stream 116.

The computing device 14 receives the video stream 116-C and the controller 56 begins an analysis of a segment of the video stream 116-C. The term “segment” in this context simply means that a portion of the video stream 116-C is analyzed. The controller 56 may initially utilize the same mocap generation technology utilized in the mocap generator 100 to analyze the high-resolution images in the video stream 116-C and to generate generated mocap data 118 that quantifies facial expressions of the individual depicted in the video stream 116-C.

The generated mocap data 118 can then be compared to the mocap data 42. Any suitable algorithm for comparing the generated mocap data 118 to the mocap data 42 to determine a similarity, or lack thereof, between the two may be used. In one implementation a range( ) function can be used to determine similarity, or lack thereof, between the two. The controller 56 generates a mocap score 120 based on the comparison.

The controller 56 may then input one or more images derived from the video stream 116-C that depict hair of the individual depicted in the video stream 116-C. In some implementations the controller 56 may utilize object detection or pattern matching algorithms on images from the video stream 116-C and extract a portion of the image that depicts the hair of the individual depicted in the video stream 116-C. The controller 56 may input one or more images into the hair MLM 44 to obtain predictions that the hair depicted in the one or more images is the hair of the known individual. The images may include the hairline, where the scalp transitions from no hair to hair. The controller 56 stores the prediction as a hair MLM score 122.

The controller 56 may input one or more images derived from the video stream 116-C that depict skin of the individual depicted in the video stream 116-C. In some implementations the controller 56 may utilize object detection or pattern matching algorithms on images from the video stream 116-C and extract a portion of the image that depicts the skin of the individual depicted in the video stream 116-C. The controller 56 may input one or more images into the skin MLM 46 to obtain predictions that the skin depicted in the one or more images is the skin of the known individual. The skin MLM 46 may also include training based on the eyes of the known individual. In other implementations, a separate eye MLM may be trained and used. The controller 56 stores the prediction as a skin MLM score 124.

The controller 56 may input one or more images derived from the video stream 116-C that depict facial muscles and/or wrinkles of the individual depicted in the video stream 116-C, including, for example, the forehead of the individual. The controller 56 may input one or more images into the facial MLM 48 to obtain predictions that the facial muscles and/or wrinkles depicted in the one or more images are the facial muscles and/or wrinkles of the known individual. The controller 56 stores the prediction as a facial MLM score 126.

The controller 56 may capture audio data from the video stream 116-C and generate generated voice signals 128 having a same format as the audio data 50. The controller 56 may then compare the generated voice signals 128 to the audio data 50 to determine a similarity. The controller 56 may generate an audio analysis score 130 based on the comparison.

The controller 56 may then generate an aggregate score 132 based on the mocap score 120, the hair MLM score 122, the skin MLM score 124, the facial MLM score 126, and the voice signal score 130. The controller 56 may use any suitable formula to combine the scores to generate the aggregate score 132. The scores may be given the same weight or different weights. Based on the aggregate score 132, the controller 56 generates an output signal 134 indicative of a confidence level that the video stream 116 is a video stream generated by B_SMITH. The output signal 134 may comprise the aggregate score 132, or information derived from the aggregate score 132. The browser 62 receives the output signal 134 and may present information based on the output signal 134, such as, in this example, a message 136. In some implementations the message may be presented concurrently with the presentation of the video stream 116. In other implementations, the browser 62 may await the output signal 134 prior to presenting the video stream 116 on the display device 24-2. If the output signal 134 is indicative of a low confidence that the video stream 116 is a video stream generated by the B_SMITH, the browser 62 may only present the message 136 and allow the user 26-2 to indicate whether to continue or to terminate the video stream 116.

It is noted that, while the various analyses have been described in a particular order, it is noted that the analyses can be performed in any order, including in parallel in some implementations. Moreover, while a number of analyses have been described, in other implementations only one analysis may be performed, or any combination of one or more of the analyses described herein may be performed.

It is further noted that, because the controller 56 is a component of the computing device 14, functionality implemented by the controller 56 may be attributed to the computing device 14 generally. Moreover, in examples where the controller 56 comprises software instructions that program the processor device 34 to carry out functionality discussed herein, functionality implemented by the controller 56 may be attributed herein to the processor device 34.

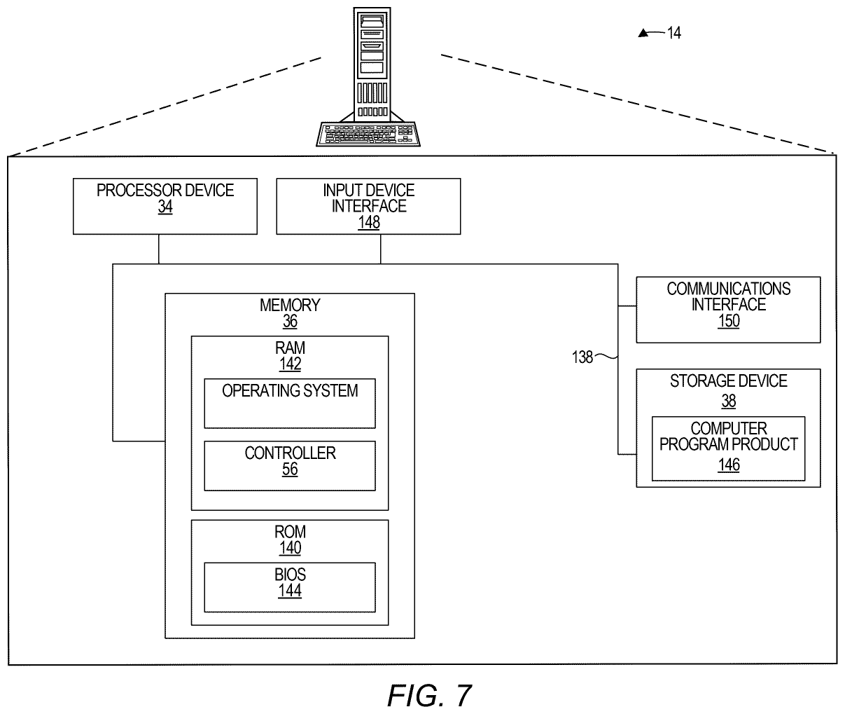

FIG. 7 is a block diagram of the computing device 14 suitable for implementing examples according to one example. The computing device 14 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 14 includes the processor device 34, the system memory 36, and a system bus 138. The system bus 138 provides an interface for system components including, but not limited to, the system memory 36 and the processor device 34. The processor device 34 can be any commercially available or proprietary processor.

The system bus 138 may be any of several types of bus structures that may further interconnect to a memory bus (with or without a memory controller), a peripheral bus, and/or a local bus using any of a variety of commercially available bus architectures. The system memory 36 may include non-volatile memory 140 (e.g., read-only memory (ROM), erasable programmable read-only memory (EPROM), electrically erasable programmable read-only memory (EEPROM), etc.), and volatile memory 142 (e.g., random-access memory (RAM)). A basic input/output system (BIOS) 144 may be stored in the non-volatile memory 140 and can include the basic routines that help to transfer information between elements within the computing device 14. The volatile memory 142 may also include a high-speed RAM, such as static RAM, for caching data.

The computing device 14 may further include or be coupled to a non-transitory computer-readable storage medium such as the storage device 38, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 38 and other drives associated with computer-readable media and computer-usable media may provide non-volatile storage of data, data structures, computer-executable instructions, and the like.

A number of modules can be stored in the storage device 38 and in the volatile memory 142, including an operating system and one or more program modules, such as the controller 56, which may implement the functionality described herein in whole or in part. All or a portion of the examples may be implemented as a computer program product 146 stored on a transitory or non-transitory computer-usable or computer-readable storage medium, such as the storage device 38, which includes complex programming instructions, such as complex computer-readable program code, to cause the processor device 34 to carry out the steps described herein. Thus, the computer-readable program code can comprise software instructions for implementing the functionality of the examples described herein when executed on the processor device 34. The processor device 34, in conjunction with the file transfer module 26 in the volatile memory 142, may serve as a controller, or control system, for the computing device 14 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 34 through an input device interface 148 that is coupled to the system bus 138 but can be connected by other interfaces such as a parallel port, an Institute of Electrical and Electronic Engineers (IEEE) 1394 serial port, a Universal Serial Bus (USB) port, an IR interface, and the like. The computing device 14 may also include a communications interface 150 suitable for communicating with a network or other computing devices as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a computing device, a video stream that depicts at least a face of an individual, and information identifying a known individual;
accessing, by the computing device, predetermined validation data derived from the known individual;
performing an analysis, by the computing device, of a segment of the video stream based on the predetermined validation data; and
providing, by the computing device based on the analysis, an output signal indicative of a confidence level that the video stream is a video stream generated by the known individual.

2. The method of claim 1, wherein the predetermined validation data comprises motion capture data that includes motion capture data quantifying facial expressions of the known individual while speaking.

3. The method of claim 2, wherein performing the analysis, by the computing device, of the segment of the video stream based on the predetermined validation data comprises:
generating, by the computing device, generated motion capture data that quantifies facial expressions of the individual depicted in the segment of the video stream; and
comparing, by the computing device, the generated motion capture data to the motion capture data quantifying facial expressions of the known individual while speaking.

4. The method of claim 1, wherein the predetermined validation data comprises imagery depicting facial muscles and/or facial wrinkles of the known individual.

5. The method of claim 4, wherein performing the analysis, by the computing device, of the segment of the video stream based on the predetermined validation data comprises:
inputting, by the computing device, the segment of the video stream into a machine learned model that was trained with the imagery depicting the facial muscles and/or the facial wrinkles of the known individual.

6. The method of claim 1, wherein the predetermined validation data comprises imagery depicting hair of the known individual.

7. The method of claim 6, wherein performing the analysis, by the computing device, of the segment of the video stream based on the predetermined validation data comprises:
inputting, by the computing device, the segment of the video stream into a machine learned model that was trained with the imagery depicting hair of the known individual.

8. The method of claim 1, wherein the predetermined validation data comprises imagery depicting skin of the known individual.

9. The method of claim 8, wherein performing the analysis, by the computing device, of the segment of the video stream based on the predetermined validation data comprises:
inputting, by the computing device, the segment of the video stream into a machine learned model that was trained with the imagery depicting the skin of the known individual.

10. The method of claim 1, wherein the predetermined validation data comprises audio data generated from voice signals of the known individual.

11. The method of claim 10, wherein performing the analysis, by the computing device, of the segment of the video stream based on the predetermined validation data comprises:
comparing, by the computing device, audio data contained in the segment of the video stream to the audio data generated from the voice signals of the known individual.

12. The method of claim 1, wherein the video stream is a live video stream being streamed from a first computing device to a second computing device, and wherein the computing device receives the video stream from the second computing device, and wherein the computing device provides the output signal to the second computing device.

13. The method of claim 1, wherein the video stream is a live video stream being streamed from a first computing device to a second computing device, and wherein the computing device comprises the second computing device.

14. The method of claim 1, wherein the predetermined validation data derived from the known individual comprises at least two of:
motion capture data that includes motion capture data quantifying facial expressions of the known individual while speaking;
imagery depicting facial muscles and/or facial wrinkles of the known individual;
imagery depicting hair of the known individual;
imagery depicting skin of the known individual; and
audio data generated from voice signals of the known individual.

15. The method of claim 14, wherein performing the analysis, by the computing device, of the segment of the video stream based on the predetermined validation data, comprises at least two of:
a) generating, by the computing device, generated motion capture data that quantifies facial expressions of the individual depicted in the segment of the video stream;
comparing, by the computing device, the generated motion capture data to the motion capture data quantifying facial expressions of the known individual while speaking;
b) inputting, by the computing device, the segment of the video stream into a first machine learned model that was trained with the imagery depicting the facial muscles and/or the facial wrinkles of the known individual;
c) inputting, by the computing device, the segment of the video stream into a second machine learned model that was trained with the imagery depicting the hair of the known individual;
d) inputting, by the computing device, the segment of the video stream into a third machine learned model that was trained with the imagery depicting the skin of the known individual; or
e) comparing, by the computing device, audio data contained in the segment of the video stream to the audio data generated from the voice signals of the known individual.

16. A computing device, comprising:
a memory; and
a processor device coupled to the memory operable to
receive a video stream that depicts at least a face of an individual, and information identifying a known individual;
access predetermined validation data derived from the known individual;
perform an analysis of a segment of the video stream based on the predetermined validation data; and
provide, based on the analysis, an output signal indicative of a confidence level that the video stream is a video stream generated by the known individual.

17. The computing device of claim 16, wherein the predetermined validation data comprises motion capture data that includes motion capture data quantifying facial expressions of the known individual while speaking.

18. The computing device of claim 16, wherein the predetermined validation data comprises imagery depicting skin of the known individual.

19. A non-transitory computer-readable storage medium that includes executable instructions operable to cause one or more processor devices to:
receive a video stream that depicts at least a face of an individual, and information identifying a known individual;
access predetermined validation data derived from the known individual;
perform an analysis of a segment of the video stream based on the predetermined validation data; and
provide, based on the analysis, an output signal indicative of a confidence level that the video stream is a video stream generated by the known individual.

20. The non-transitory computer-readable storage medium of claim 19, wherein the predetermined validation data comprises motion capture data that includes motion capture data quantifying facial expressions of the known individual while speaking.
